(19) United States
(12) Patent Application Publication
(10) Pub. No.: US 2024/0068190 A1
(43) Pub. Date: Feb. 29, 2024

(54) ELECTRIC SNOWTHROWER WITH ADAPTIVE MOTOR AND CONTROLS FOR USE WITH SAME

(71) Applicant: THE TORO COMPANY, Bloomington, MA (US)

(72) Inventors: Derek S. Duchscherer, Eden Prairie, MN (US); Todd A. Porter, Rosemount, MN (US); Chris A. Wadzinski, Inver Grove Heights, MN (US)

(21) Appl. No.: 18/237,085

(22) Filed: Aug. 23, 2023

Related U.S. Application Data
(60) Provisional application No. 63/402,175, filed on Aug. 30, 2022.

(51) Int. Cl. E01H 5/09; H02P 23/14

(52) U.S. Cl. CPC E01H 5/098; H02P 23/14

(57) ABSTRACT

An electric snowthrower including: an auger and an impeller driven by one or more electric motors; one or more sensors; and an electronic controller coupled to each of the motor(s) and the sensor(s). The electronic controller is configured to monitor data provided by the sensor(s) and, in response to the sensor data, automatically adjust operation of the motor(s) or other feature of the snowthrower. Controls for operating such a snowthrower are also included.

The present application claims priority to and/or the benefit of U.S. Provisional Patent Application No. 63/402,175, filed Aug. 30, 2022, which is incorporated herein by reference in its entirety.

Embodiments described herein are directed generally to snowthrowers, and more specifically, to electric snowthrowers.

### BACKGROUND

Snowthrowers typically fall into one of two categories. Single stage snowthrowers typically achieve both snow collection and ejection using a single horizontally-mounted, high-speed rotor. The rotor may be shaped to move the snow transversely toward a discharge area. At or near the discharge area, the rotor may include paddles configured to directly eject the snow outwardly through a discharge chute. Single-stage snowthrowers may be either self-propelled or push-powered.

Conversely, two-stage snowthrowers include a horizontally-mounted, rigid helical auger that cuts snow and moves it at a low speed transversely toward a discharge area. Once the snow reaches the discharge area, a higher speed impeller collects and ejects the snow outwardly away from the snowthrower through a discharge chute. Wheels supporting two-stage snowthrowers are typically powered to propel the snowthrower over a ground surface during operation.

Snow that is collected by the snowthrower (e.g., resulting from forward propulsion) may sometimes overload the auger and/or the impeller (for two-stage snowthrowers) or the rotor (for single stage machines). Such an overload may result when, for example, propulsion speed is too high for the particular depth and density of the collected snow (that is, the rate of snow mass collection exceeds the snowthrower's ejection capacity). Such overload situations may sometimes result in clogging or stalling of the snowthrower.

### SUMMARY

In one or more embodiments of the present disclosure, a snowthrower may be provided that includes: an auger housing containing an auger therein; an electric auger motor operatively coupled to the auger and configured to rotate the auger about an auger axis; an impeller housing in fluid communication with the auger housing, wherein the impeller housing contains an impeller therein; an electric impeller motor operatively coupled to the impeller and configured to rotate the impeller about an impeller axis; at least one sensor; and an electronic controller operatively coupled to each of the auger motor, the impeller motor, and the sensor. The electronic controller is configured to: monitor data provided by the sensor; and responsive to the data provided by the sensor, automatically adjust a parameter of one or both of the auger motor and the impeller motor.

In another embodiment, a snowthrower is provided that includes: an auger housing containing an auger therein; an impeller housing in fluid communication with the auger housing, wherein the impeller housing contains an impeller therein; and an electric motor operatively coupled: to the auger and configured to rotate the auger about an auger axis; and to the impeller and configured to rotate the impeller about an impeller axis. The snowthrower also includes: at least one sensor; and an electronic controller operatively coupled to each of the electric motor and the sensor. The electronic controller is configured to: monitor data provided by the sensor; and responsive to the data provided by the sensor, automatically adjust a parameter of the electric motor.

In another embodiment of the present disclosure, a snowthrower is provided that includes: a frame defining a longitudinal axis and a center of gravity; and a traction assembly comprising at least one traction wheel supporting the frame relative to a ground surface. A longitudinal position of the traction wheel is movable between a longitudinal first position and a longitudinal second position, wherein the first position is forward of the second position. The snowthrower further includes: an electric traction motor operatively coupled to the traction wheel and configured to rotate the traction wheel about a traction axis transverse to the longitudinal axis; an auger housing located on the frame, the auger housing containing an auger therein; an electric auger motor operatively coupled to the auger and configured to rotate the auger about an auger axis transverse to the longitudinal axis; an impeller housing in fluid communication with the auger housing, the impeller housing containing an impeller therein; an electric impeller motor operatively coupled to the impeller and configured to rotate the impeller about an impeller axis; at least one sensor; and an electronic controller operatively coupled to each of the auger motor, the impeller motor, the traction motor, the traction assembly, and the sensor. The electronic controller is configured to: monitor data generated by the sensor; and responsive to the data generated by the sensor, automatically adjust a parameter of one or more of the auger motor, the impeller motor, the traction motor, and the traction assembly.

In still another embodiment, a snowthrower is provided that includes: a frame defining a longitudinal axis; a traction assembly supporting the frame relative to a ground surface, the traction assembly comprising at least one traction wheel; an electric traction motor operatively coupled to the traction wheel and configured to rotate the traction wheel about a traction axis transverse to the longitudinal axis to propel the snowthrower over the ground surface; and operator controls operatively coupled to the electric traction motor. The operator controls include: a first traction control configured to command rotation of the traction wheel via the electric traction motor; and first and second shift controls configured to adjust a rotational speed of the traction wheel via the electric traction motor. The rotational speed of the traction wheel is adjustable between a plurality of discrete speeds, wherein the plurality of discrete speeds includes: a neutral speed; and a first forward speed.

In still yet another embodiment, a snowthrower is provided that includes: a frame defining a longitudinal axis; a traction assembly supporting the frame relative to a ground surface, the traction assembly comprising a first traction wheel and a second traction wheel; a first electric traction motor operatively coupled to the first traction wheel and configured to rotate the first traction wheel about a traction axis transverse to the longitudinal axis to propel the snowthrower over the ground surface; a second electric traction motor operatively coupled to the second traction wheel and configured to rotate the second traction wheel about the traction axis; and operator controls operatively coupled to each of the electric traction motors. The operator controls include: a first propulsion control configured to proportionally adjust rotational speed of the first traction wheel via the first electric traction motor; and a second propulsion control configured to proportionally adjust rotational speed of the second traction wheel via the second electric traction motor.

In yet another embodiment, a snowthrower is provided that includes: a frame defining a longitudinal axis; a traction assembly supporting the frame relative to a ground surface, the traction assembly comprising a first traction wheel and a second traction wheel; an electric traction motor operatively coupled to: the first traction wheel via a first transmission unit; and the second traction wheel via a second transmission unit; and operator controls operatively coupled to each of the first and second transmission units. The operator controls include: a first propulsion control configured to proportionally adjust rotational speed of the first traction wheel via the first transmission unit; and a second propulsion control configured to proportionally adjust rotational speed of the second traction wheel via the second transmission unit.

In still another embodiment, a snowthrower is provided that includes: an auger housing containing an auger therein; an impeller housing in fluid communication with the auger housing, wherein the impeller housing contains an impeller therein; a motor assembly with at least one electric motor operatively coupled to each of the auger and the impeller, wherein the motor assembly is configured to rotate each of the auger and the impeller about an auger axis and an impeller axis, respectively; at least one sensor; and an electronic controller operatively coupled to each of the motor assembly and the sensor. The electronic controller is configured to: monitor data provided by the sensor; and responsive to the data provided by the sensor, automatically adjust a parameter of the motor assembly. The motor assembly may optionally include a gearbox operatively coupled to each of the auger and the at least one electric motor, and the at least one electric motor may be configured to rotate the auger about the auger axis via the gearbox.

The above summary is not intended to describe each embodiment or every implementation. Rather, a more complete understanding of illustrative embodiments will become apparent and appreciated by reference to the following Detailed Description of Illustrative Embodiments and claims in view of the accompanying figures of the drawing.

### BRIEF DESCRIPTION OF THE VIEWS OF THE DRAWING

Exemplary embodiments will be further described with reference to the figures of the drawing, wherein:

FIG. 1 is a left front perspective view of a snowthrower in accordance with one or more embodiments of the present disclosure;

FIG. 2 is a right side elevation view of a snowthrower in accordance with one or more embodiments of the present disclosure;

FIG. 3 is a perspective view of exemplary operator controls configured for operating snowthrowers in accordance with embodiments of the present disclosure;

FIG. 4 is a diagrammatic view of a snowthrower in accordance with embodiments of the present disclosure including an electric impeller motor and an electric auger motor; and

FIG. 5 is a diagrammatic view of a snowthrower in accordance with alternative embodiments of the present disclosure.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described. The lack of illustration/description of such structure/components in a particular figure is, however, not to be interpreted as limiting the various embodiments in any way.

### DETAILED DESCRIPTION OF ILLUSTRATIVE EMBODIMENTS

In the following detailed description of illustrative embodiments, reference is made to the accompanying figures of the drawing which form a part hereof. It is to be understood that other embodiments, which may not be described and/or illustrated herein, are certainly contemplated. Unless otherwise indicated, all numbers expressing quantities, and all terms expressing direction/orientation (e.g., vertical, horizontal, parallel, perpendicular, etc.) in the specification and claims are to be understood as being modified in all instances by the term “about.” The term “and/or” (if used) means one or all of the listed elements or a combination of any two or more of the listed elements. “I.e.” is used as an abbreviation for the Latin phrase id est and means “that is.” “E.g.” is used as an abbreviation for the Latin phrase exempli gratia and means “for example.”

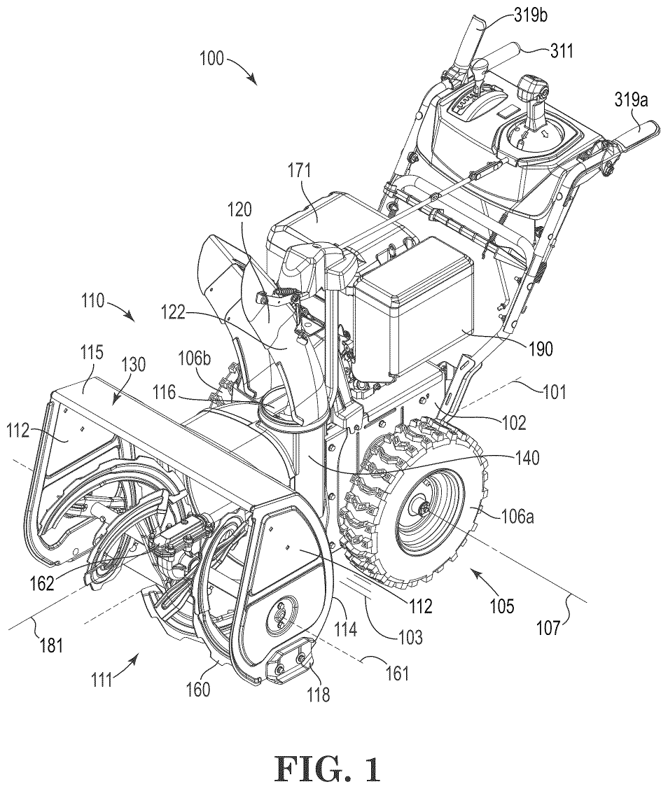

With reference to the figures of the drawing, wherein like reference numerals designate like parts and assemblies throughout the several views, FIG. 1 illustrates a dedicated self-propelled, two-stage snowthrower 100. While so described and illustrated, such a construction is not limiting as aspects of the depicted/described embodiments may find application to other types of snowthrowers (e.g., those that attach as implements to general purpose or other vehicles, single-stage snowthrowers, etc.) as well as to other types of power equipment.

It is noted that the terms “comprises” and variations thereof do not have a limiting meaning and are used in their open-ended sense to generally mean “including but not limited to” where these terms appear in the accompanying description and claims. Further, “a,” “an,” “the,” “at least one,” and “one or more” are used interchangeably herein. Moreover, relative terms such as “left,” “right,” “front,” “fore,” “forward,” “rear,” “aft,” “rearward,” “top,” “bottom,” “side,” “upper,” “lower,” “above,” “below,” “horizontal,” “vertical,” and the like may be used herein and, if so, are from the perspective of one operating the snowthrower 100 while the snowthrower is in an operating configuration, e.g., while the snowthrower 100 is positioned such that traction wheels 106 and skids 118 rest upon a generally horizontal ground surface 103 as shown in FIG. 1. These terms are used only to simplify the description, however, and not to limit the interpretation of any described embodiment.

Still further, the suffixes “a” and “b” may be used throughout this description to denote various left- and right-side parts/features, respectively. However, in most pertinent respects, the parts/features denoted with “a” and “b” suffixes are substantially identical to, or mirror images of, one another. It is understood that, unless otherwise noted, the description of an individual part/feature (e.g., part/feature identified with an “a” suffix) also applies to the opposing part/feature (e.g., part/feature identified with a “b” suffix). Similarly, the description of a part/feature identified with no suffix may apply, unless noted otherwise, to both the corresponding left and right part/feature.

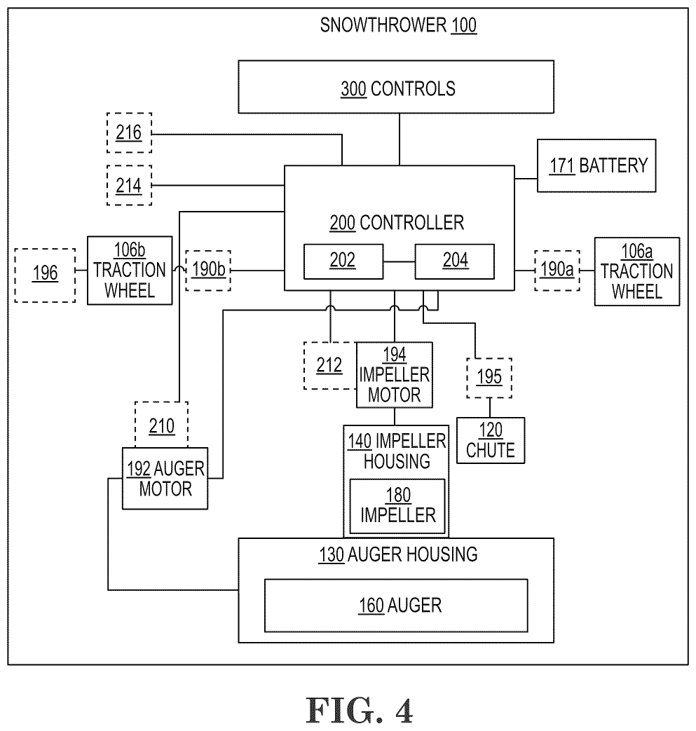

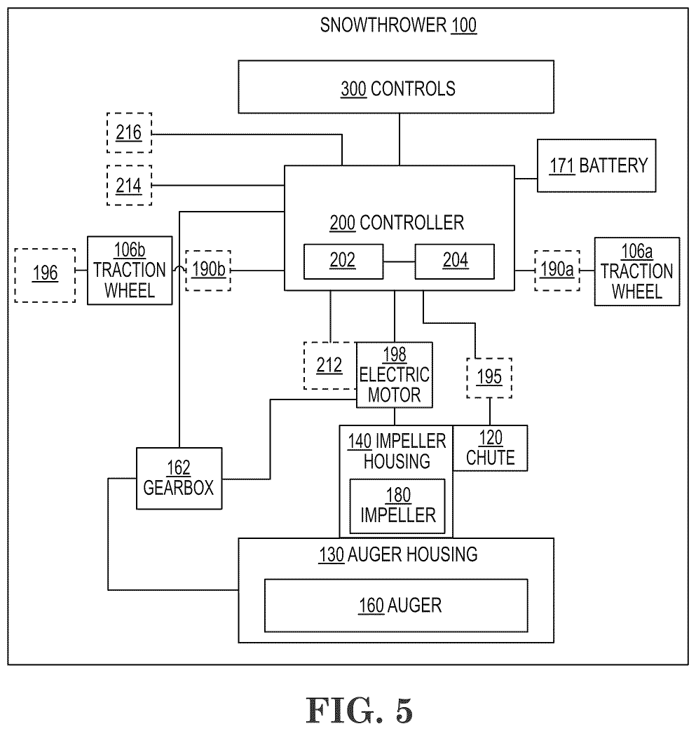

As illustrated in FIG. 1, the snowthrower 100 may include a chassis or frame 102 (having first and second lateral sides and defining a centerline longitudinal axis 101). One or more, e.g., first and second, drive members such as traction wheels 106 (first or left wheel 106a and second or right wheel 106b) may be coupled, one on or near each of the first (e.g., left) and a second (e.g., right) side of the frame/auger housing. The traction wheels 106 may each rotate about a traction axis 107 (transverse to the longitudinal axis, and which may be the same or a different axis for each wheel) and may form a portion of a traction assembly 105 supporting the frame relative to the ground surface. The traction assembly 105 may further include one or more electric traction motors (e.g., electric traction motor 190) operatively coupled to the traction wheels 106 and configured to rotate the traction wheels about the traction axis 107 to propel the snowthrower over/relative to the ground surface (while shown as remote from the traction wheels 106, the traction motor 190 may also be located at or near the traction axis 107). The electric traction motor 190 may be coupled to an electronic controller 200 described in more detail below with respect to FIGS. 4 and 5.

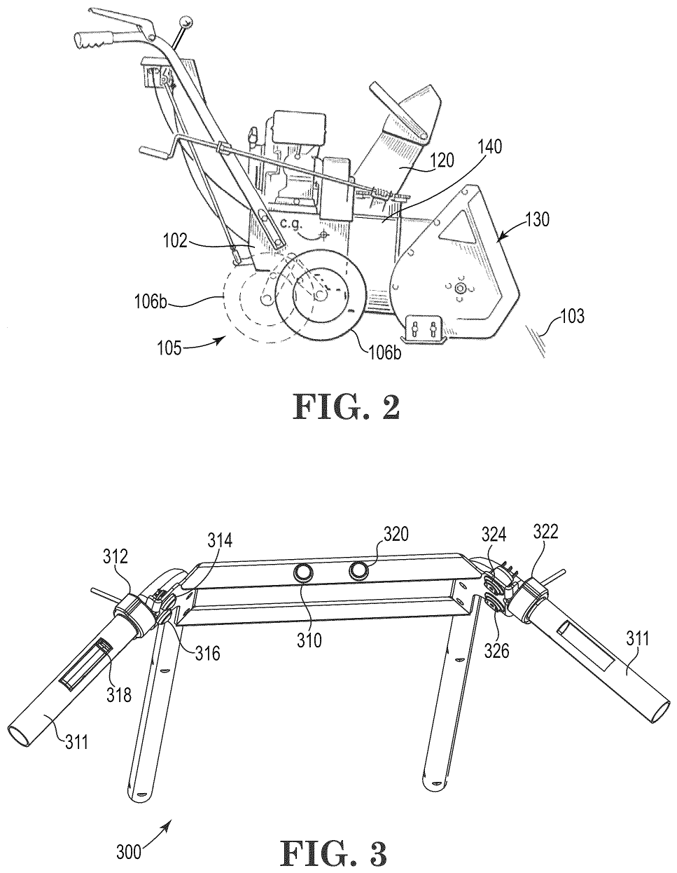

In some embodiments, the traction assembly 105 (including the traction wheels 106) may be movable between two or more longitudinal positions as shown in FIG. 2 to effectively shift the traction wheels 106 relative to a center of gravity (“c.g.”) of the snowthrower 100. To achieve this movement, the traction assembly 105 may further include one or more traction assembly actuators 196 (see FIG. 4) configured to move the traction wheels 106 between the two or more longitudinal positions (e.g. between a first longitudinal position and a second longitudinal position that is aft of the first longitudinal position). In some embodiments, the traction assembly actuator 196 may include an electric motor. Moving the traction wheels in this manner is described generally in U.S. Pat. No. 4,756,101.

With reference again to FIG. 1, one or more battery packs (e.g., battery back 171) may be carried by the frame 102. The battery pack(s) 171 may be configured to supply electrical power to the snowthrower 100, e.g., to the various snowthrower components. The battery pack(s) 171 may be of a lithium-based chemistry (e.g., lithium ion, lithium polymer). However, batteries of other chemistries (e.g., nickel-metal hydride, nickel-cadmium, etc.) are also possible, as are other types of electrical energy sources. While described and illustrated as using an on-board battery pack, most any electrical power supply configuration, e.g., externally-provided AC power, external battery system, fuel cell, or the like may also be utilized.

As stated above, the traction wheels 106 may be selectively powered by the electric traction motor 190 to propel the snowthrower 100 relative to or over the ground surface 103 generally in a direction parallel to the longitudinal axis 101 (when travelling in a straight line). The snowthrower 100 may change directions (turn) by differential rotation of the traction wheels 106a, 106b. For example, each wheel may be selectively de-clutched from the traction motor 190 while the opposite wheel remains powered to affect a turn. In other embodiments, each traction wheel 106a, 106b may be coupled to its own traction motor 190a, 190b (as shown in FIG. 4). Alternatively, differential rotation of the traction wheels may be provided by an independent transmission unit dedicated to each traction wheel. For example, an electric traction motor may be operatively coupled to a left traction wheel (e.g., the traction wheel 106a) via a left transmission unit (not shown) and the same electric traction motor may be operatively coupled to a right traction wheel (e.g., the traction wheel 106b) via a right transmission unit (not shown). In such embodiments, the snowthrower may execute a zero-radius turn by simultaneous forward rotation of one transmission and reverse rotation of the other transmission.

As used herein, the term “wheel” is understood to include at least a support portion (e.g., rim) and a ground contacting portion (e.g., tire). The tire may be of most any configuration (e.g., pneumatic, non-pneumatic, solid) and be made of most any material (e.g., rubber, plastic, metal, etc.). While described and illustrated as wheels, most any drive member configuration, e.g., tracks, rollers, or the like, may also be utilized.

The exemplary snowthrower 100 may further include a snowthrower housing 110 attached to the frame 102. The housing 110 may include a pair of spaced-apart sidewalls 112 connected to one another by a rear wall 114 and an upper wall 115 such that the housing 110 forms a generally front-facing collection opening 111 forward of, and in fluid communication with, a partially enclosed chamber containing therein a horizontal auger 160 (i.e., the auger 160 may be positioned between the collection opening 111 and the rear wall 114). Lowermost portions of the housing 110 (e.g., the skids 118; only left skid being visible in FIG. 1), together with the traction wheels 106, may form ground contact portions of the snowthrower 100.

In one or more embodiments, the housing 110 includes both an auger housing 130 containing the auger 160 and an impeller housing 140 in fluid communication with the auger housing and containing an impeller 180 therein as shown in FIGS. 4 and 5 (not visible in FIG. 1). The auger housing 130 may define a discharge opening or outlet 116 connected to a discharge chute 120. The discharge chute 120 may be defined by sidewalls 122 such that a passageway formed by the sidewalls is operatively coupled to the housing 110. The discharge chute 120 thus fluidly communicates with the discharge outlet 116 so that snow within the housing 110 may be ejected through the discharge outlet 116 and directed in a specific direction by the discharge chute 120.

The auger 160 may be selectively powered by one or more electric motors (e.g., auger motor 192 as shown in FIG. 4) to rotate about a transverse auger axis 161 (see FIG. 1). As used herein, “longitudinal axis” or “longitudinal direction” refers to a long axis of the snowthrower 100, e.g., the centerline longitudinal axis 101 extending in the travel or fore-and-aft direction as shown in FIG. 1. “Transverse” or “transverse axis” refers to a direction or axis extending side-to-side, e.g., a horizontal axis that is normal or transverse to a vertical plane containing the longitudinal axis 101 of the snowthrower 100. During operation, the auger 160 rotates such that snow entering the collection opening 111 (e.g., due to forward propulsion of the snowthrower 100) is collected by the auger 160 and moved towards the center of the auger housing 130. Specifically, the auger 160 may rotate such that snow captured between the sidewalls 112 is directed towards the center of the collection opening 111, where it then enters the impeller housing 140. To permit such rotation, the auger 160 may be coupled to an auger shaft rotatably supported by the sidewalls 112 and extending along the auger axis 161. The auger shaft may then be connected to a gearbox 162 powered by the auger motor 192. In some embodiments, the auger motor 192 may be directly connected to the auger shaft (e.g., replacing the gearbox 162 or positioned at a left and/or right end of the auger shaft).

The impeller 180 (see FIG. 4) is configured to receive snow transported by the auger 160 and eject the snow outwardly through the discharge outlet 116 via the chute 120. The impeller 180 may be operatively coupled to one or more electric impeller motors (e.g., electric impeller motor 194) to rotate about an impeller axis 181 that is perpendicular to the transverse auger axis 161.

The discharge chute 120 may be configured to rotate about a chute axis and may include an adjustable deflector to assist with directing snow exiting the discharge chute 120. In one or more embodiments, the discharge chute 120 may be operatively coupled to one or more electric chute motors (e.g., the electric chute motor 195 as shown in FIG. 4), for example, to selectively rotate the discharge chute 120 about the chute axis and/or to adjust the deflector.

In one or more embodiments, the snowthrower 100 may include operator controls 300, such as those shown in FIG. 3, to control various functions and/or components of the snowthrower 100. In the illustrated embodiments, some or all of the operator controls 300 are “drive-by-wire” controls in that the controls themselves provide electrical signals to the controller 200 (see FIG. 4) and the controller then issues commands (e.g., to the various motors) based thereon. In the example illustrated in FIG. 3, the controls 300 may include one or more thumb paddles (e.g., the left and right thumb paddles 312, 322), one or more two-position momentary buttons (e.g., the top and bottom buttons 314, 316), and one or more three-position momentary switches (e.g., the top and bottom switches 324, 326).

The thumb paddles 312, 322 may be provided for variable or binary control of aspects of snowthrower 100 operation. In one or more embodiments, the thumb paddles may be provided as propulsion controls. For example, first and second proportional traction controls (e.g., the thumb paddles 312, 322) may proportionally control (e.g., proportionally adjust) the speed of the traction wheels 106 via the traction motor(s) 190. In embodiments including the thumb paddles 312, 322, the speed of the traction wheels 106 may be proportionally controlled by rotation of the thumb paddles 312, 322 about the handles 311. In such a variable, or proportional, speed control embodiment, a first traction control (e.g., the left thumb paddle 312) may proportionally control the speed of a first traction wheel (e.g., the left traction wheel 106a) via a first traction motor (e.g., a left traction motor 190a (see FIG. 4)) and a second traction control (e.g., the right thumb paddle 322) may proportionally control the speed of a second traction wheel (e.g., a right traction wheel 106b) via a second traction motor (e.g., the right traction motor 190b). In such embodiments, the snowthrower 100 may execute a turn, for example, by differential input to the thumb paddles. Alternatively, a first traction control (e.g., left thumb paddle 312 or right thumb paddle 322) may control both of the traction wheels 106 via the one or more traction motors (e.g., the traction motor 190). In such embodiments, the snowthrower 100 may execute a turn, for example, by selectively de-clutching one traction wheel from the traction motor 190.

In another example, one or more control grips may be provided as propulsion controls. The one or more control grips may be rotational about respective axes (e.g., handles 311). Functions provided by the thumb paddles may be similarly provided by the control grips. That is to say, for example, rotation of the control grips about the respective axes proportionally control the speed of the respective traction wheels 106 (e.g., via the traction motor(s) 190 and/or the transmission unit(s)), by rotation of the control grips about the handles 311. One or more controls (e.g., the two-position momentary buttons 314, 316, and/or the top and bottom switches 324, 326) may be mounted on the control grips and rotate about the axes therewith.

In yet another example, the propulsion controls may be activated (in binary or variable fashion) by sensing a load applied to handles of the snowthrower. That is to say, the handles 311 may be configured to detect a load applied to the handles (i.e., by the operator) and, responsive to the load detected, alter the speed of the traction wheels in proportion to the load.

In conjunction with the thumb paddles 312, 322, the two-position momentary buttons 314, 316, may allow control of speed or direction of one or more motors. For example, the top button 314 may be used to command forward propulsion and the bottom button 316 may be used to command (e.g., activate) reverse propulsion of the snowthrower 100. Accordingly, the thumb paddles 312, 322 may provide proportional control of the speed of rotation of their respective left and right traction wheels 106, while the top and bottom buttons 314, 316 may control wheel rotational direction (forward and reverse, respectively).

While described above as providing proportional speed control, the thumb paddles 312, 322 may alternatively provide binary control. For example, the thumb paddles 312, 322 may binarily control propulsion via rotation of the traction wheels 106a, 106b, respectively, while shift controls (e.g., the top and bottom buttons 314, 316) may provide control for the speed and direction of rotation of the traction wheels 106. For instance, a first shift control (e.g., the top button 314) and a second shift control (e.g., the bottom button 316) may be used to shift up and down between a plurality of discrete propulsion speeds (i.e., discrete rotational speeds of the traction wheels 106), such as between one or more discrete reverse speeds, a neutral (zero) speed, and one or more discrete forward speeds. In such embodiments, the adjustment of propulsion speed and/or direction of propulsion may function like a paddle shifter.

As an example of such binary operation, the first shift control (e.g., the top button 314) could be pressed to switch from a second reverse speed to a first reverse speed that is slower than the second reverse speed. The first shift control may be pressed again to shift from the first reverse speed to neutral (zero speed). Pressing the first shift control yet again may shift from neutral to a first forward speed. The first shift control may be pressed repeatedly to incrementally change to corresponding higher forward speeds with each press, where each forward speed is faster than the previous forward speed. Likewise, the second shift control (e.g., the bottom button 316) may be pressed to reduce speed, e.g., reduced speed from a third forward speed to a second forward speed that is slower than the third forward speed and so on. With each press of the second shift control, the controller 200 may continue reducing speed downwardly through various forward speeds through neutral, and then through the reverse speeds. The number of forward speeds and reverse speeds may, of course, vary without departing from the scope of this disclosure.

The snowthrower 100 may execute turns by differential rotation of the left traction wheel 106a and right traction wheel 106b via differential movement of the first traction control (e.g., the left thumb paddle 312) and the second traction control (e.g., the right thumb paddle 322). In other embodiments where one traction control (e.g., the left or right thumb paddles 312 or 322) controls both traction wheels 106, the snowthrower may execute a turn, for example, by selectively disengaging rotation of one of the traction wheels 106.

The controls 300 may also include one or more accessory buttons. For example, an accessory button 320 may be provided to activate an accessory, such as headlamps, zone lighting, and/or hand warmers. In another embodiment, the accessory button 320 may be provided to manually move the traction wheels 106 between the first longitudinal position (see solid line representation in FIG. 2) and the second longitudinal position (broken line representation in FIG. 2).

In some embodiments, the controls 300 may also include an operator presence control (“OPC”) lever 318 as shown in FIG. 3. The OPC lever 318 may be pivotally attached to the handle 311 of the snowthrower 100 and be biased (e.g., by a spring) to a position where the OPC lever 318 is spaced-apart from the handle 311. By squeezing the OPC lever 318 toward the handle 311, the biasing force may be overcome and an OPC circuit may close. Once closed, various features of the snowthrower 100 may be activated. For example, engagement of the OPC lever 318 may be required to permit operation of one or more of the traction motor 190, the auger motor 192, and the impeller motor 194. In other words, the snowthrower 100 may not be propelled by the traction wheels 106 (and/or the auger 160 and/or the impeller 180 may not rotate) unless the OPC lever 318 remains depressed by the operator.

The OPC lever 318 may, in some embodiments, be part of a two-action process required to close the OPC circuit. For example, in addition to the OPC lever 318, the operator may also need to interact with a second control, e.g., a two-position momentary button 310. In exemplary embodiments, in order to actuate the auger motor 192 and/or the impeller motor 194, the operator may be required to press the button 310 before or during engagement of the OPC lever 318.

The controls 300 may also include the three-position momentary top and bottom switches 324, 326. In one exemplary embodiment, the top switch 324 may control the angle of the discharge chute deflector (i.e., to adjust the elevation of discharged snow) and the bottom switch 326 may control rotation of the discharge chute 120 about the chute axis (i.e., to adjust the direction of the discharged snow).

While described as utilizing the control interface as shown in FIG. 3, such an embodiment is exemplary only. Other embodiments may utilize more conventional controls such as those illustrated in FIG. 1. As shown in this view, the snowthrower may include engagement levers 319a, 319b wherein one of the levers 319 may be used to engage propulsion via the traction wheels 106, while the other of the levers 319 may be used to engage the auger 160/impeller 180. Each engagement lever 319 may be biased to a position where the lever is spaced-apart from the handle 311 (as shown for the right engagement lever 319b in FIG. 1). By squeezing the engagement lever 319 toward the handle 311 (as shown for the left engagement lever 319a in FIG. 1), the biasing force may be overcome and the associated function (e.g., engagement of the traction wheels 106) may be activated.

FIG. 4 is a diagrammatic depiction of a snowthrower 100 in accordance with embodiments of the present disclosure. As depicted in this view, the electronic controller 200 may be operatively coupled to one or more of the electric motors (e.g., the auger motor 192, the impeller motor 194, and/or the traction motor(s) 190a, 190b). The electronic controller 200 may further be operatively connected to at least one sensor (e.g., an impeller motor current sensor 212, an auger motor current sensor 210, an angle sensor 214 (e.g., to detect an angle of the housing 110 relative to the ground surface 103), a temperature sensor 216 (which may be associated with, for instance, any one or more of the motors or the battery packs), and to the operator controls 300. The sensors may be located on the snowthrower 100, for example, on the frame 102, the auger housing 130, the impeller housing 140, the auger motor 192, the impeller motor 194, the battery pack 171, the traction wheels 106, the traction motor 190, and/or the discharge chute 120.

As described briefly above, the controller 200 may be configured to monitor operator inputs and data provided by the sensor(s) (e.g., sensor output), and control some or all snowthrower functions based thereon. Accordingly, as shown in FIG. 4, the controller 200 may include a processor 202 that receives various inputs and executes one or more computer programs or applications stored in a memory 204. The memory 204 may include computer-readable instructions or applications that, when executed, e.g., by the processor 202, cause the controller 200 to perform various calculations and/or issue commands. That is to say, the processor 202 and the memory 204 may together define a computing apparatus operable to process input data and generate the desired output to one or more components/devices. For example, the processor 202 may receive various data such as, for example, current data from the impeller motor current sensor 212 and automatically generate or change speed commands to the auger motor 192 to cause the auger 160 to rotate at a speed better suited to a target impeller motor load.

In view of the above, it will be readily apparent that the functionality of the controller 200 may be implemented in any manner known in the art. For instance, the memory 204 may include any volatile, non-volatile, magnetic, optical, and/or electrical media, such as a random access memory (RAM), read-only memory (ROM), non-volatile RAM (NVRAM), electrically-erasable programmable ROM (EEPROM), flash memory, and/or any other digital media. While shown as both being incorporated into the controller 200, the memory 204 and the processor 202 could be contained in one or more separate modules.

The processor 202 may include any one or more of a microprocessor, a controller, a digital signal processor (DSP), an application specific integrated circuit (ASIC), a field-programmable gate array (FPGA), and/or equivalent discrete or integrated logic circuitry. In some embodiments, the processor 202 may include multiple components, such as any combination of one or more microprocessors, one or more controllers, one or more DSPs, one or more ASICs, and/or one or more FPGAs, as well as other discrete or integrated logic circuitry. The functions attributed to the controller 200/processor 202 herein may be embodied as software, firmware, hardware, or any combination thereof.

In one or more embodiments, the controller 200 may be configured to receive data from various sensors and automatically generate corresponding output commands (i.e., automatically adjust one or more parameters of the electric motor(s) and/or other aspects of snowthrower operation) in response thereto. The parameters of snowthrower operation may include: a component speed (e.g., of the impeller motor 194/impeller 180, the auger motor 192/auger 160, and/or the traction motor(s) 190/traction wheels 106); direction (e.g., rotational direction of the auger motor 192, the impeller motor 194, and/or the traction motor(s) 190); and other functions (e.g., rotational direction of the discharge chute 120 about the chute axis and/or angle of the discharge chute deflector, and/or longitudinal position of the traction wheels 106 (see FIG. 2)). The various types of sensors may include angle sensors (e.g., to detect an inclination or inclination angle of the housing 110/auger housing 130 relative to the ground surface 103), temperature sensors (e.g., to detect battery pack temperature or temperature of one or more of the impeller, auger, or traction motors, and/or to detect ambient temperature), and current sensors (e.g., to detect current to or drawn by the auger motor 192, the impeller motor 194, and/or the traction motor(s) 190).

In an exemplary embodiment, the controller 200 may control the speed of auger rotation in response to data received from the sensors. For example, in one or more embodiments, the electronic controller 200 may receive data from the impeller motor current sensor 212 indicative of the impeller 180 being under high load (“bogged down”) (e.g., because the auger 160 is feeding snow faster than the impeller 180 can effectively discharge the snow) and, responsive to the data, generate a speed command to the auger motor 192 to reduce the speed of the auger 160 and/or generate a speed command to the traction motors 190 to reduce the speed of the traction wheels 106. In other words, the controller 200 may reduce the speed of the auger 160 and/or the traction wheels 106 in response to the impeller 180 being bogged down, thereby reducing the rate at which snow is being fed to the impeller 180. Put yet another way, the electronic controller may use data provided by the sensors about various snowthrower components, functions, and/or conditions to generate commands that automatically adjust operation of the snowthrower to adapt its operation in response to those conditions. Accordingly, the snowthrower 100 may adapt to operating conditions to improve performance and extend battery life.

The controller 200 may also receive data from the angle sensor 214 indicative that the incline angle of the housing 110/longitudinal axis 101 has increased relative to the ground surface 103 to greater than a predetermined threshold incline angle (e.g., greater than 1 degree, greater than 2 degrees, greater than 5 degrees, greater than 10 degrees, or greater than 15 degrees). The controller 200 may be configured, in response to detecting the increased incline angle, to command the traction assembly 105 (e.g., via the traction assembly actuator 196) to move the traction wheels 106 from the longitudinal first position (see solid line wheel in FIG. 2) to the longitudinal second position (see broken line wheel in FIG. 2) located aft of the longitudinal first position. In other words, the snowthrower 100, responsive to the auger housing 130 attempting to climb over rather than pass through snow, may move the traction wheels 106 rearwardly relative to the c.g. of the snowthrower 100, which may effectively increase a downward force of the auger housing 130. Thus, the snowthrower may be automatically reconfigured to assist the auger housing 130 in digging into, for example, packed snow, which the snowthrower 100 may otherwise ride up and over.

In an exemplary embodiment, one or more temperature sensors, such as the temperature sensor 216, may be configured to generate data representative of the temperature of one or more of the battery packs or the motors (e.g., the auger motor 192, the impeller motor 194, and/or the traction motor(s) 190). For instance, the controller 200 may receive data from the temperature sensor 216 indicative that the temperature of the impeller motor 194 is greater than a predetermined threshold temperature (e.g., a temperature at which components of the impeller motor risk incurring damage). In response, the controller 200 may be configured to send a command to the auger motor 192 to reduce motor speed. In other words, responsive to the impeller motor 194 approaching a threshold temperature, the controller 200 may automatically reduce the rate of snow entering the impeller housing 140.

In some embodiments, the temperature sensor 216 may be configured to generate data representative of, or otherwise detect, ambient air temperature. The controller 200 may receive data from the temperature sensor 216 indicative that the ambient air temperature is greater than a predetermined baseline air temperature (e.g., greater than 30 degrees F. or greater than 32 degrees F. or greater than 35 degrees F.). In response, the controller 200 may send a command to the auger motor 192 to reduce the speed of the auger 160. In other words, the snowthrower 100, responsive to the ambient air temperature indicating snow may have an elevated moisture content, may automatically adjust auger speed to prevent the impeller 180 from potential overload caused by wet or heavy snow. Additionally or alternatively, the speed of the auger 160, the speed of the impeller 180, and/or the speed of the traction motor(s) 190 may each be automatically adjusted responsive to the ambient air temperature.

In some embodiments, the auger 160 and the impeller 180 may be powered by a single motor. For example, a diagrammatic view of an illustrative snowthrower with both of the auger 160 and the impeller 180 powered by an electric motor 198 is shown in FIG. 5. In some embodiments including both of the auger 160 and the impeller 180 being powered by a single motor, the auger shaft may be driven by the gearbox 162, which may be powered by the electric motor 198. In another example, each of the auger 160 and the impeller 180 may be powered by a motor assembly, which may include at least one electric motor (e.g., the impeller motor 194/auger motor 192, or the electric motor 198).

In one or more embodiments including the motor assembly, the motor assembly may be operatively coupled to and configured to rotate each of the impeller 180 and the auger 160 about the impeller axis 181 and the auger axis 161, respectively. The motor assembly may further include a gearbox (e.g., the gearbox 162). In at least one embodiment including the motor assembly including the gearbox, the gearbox may be operatively coupled to each of the auger 160 and the at least one electric motor, and the at least one electric motor may be configured to rotate the auger 160 about the auger axis 161 via the gearbox. Similarly, the gearbox may be operatively coupled to each of the impeller 180 and the at least one electric motor, and the at least one electric motor may be configured to rotate the impeller 180 about the impeller axis 181 via the gearbox.

The complete disclosure of the patents, patent documents, and publications cited herein are incorporated by reference in their entirety as if each were individually incorporated. In the event that any inconsistency exists between the disclosure of the present application and the disclosure(s) of any document incorporated herein by reference, the disclosure of the present application shall govern.

Illustrative embodiments are described, and reference has been made to possible variations of the same. These and other variations, combinations, and modifications will be apparent to those skilled in the art, and it should be understood that the claims are not limited to the illustrative embodiments set forth herein.

1. A snowthrower comprising:
an auger housing containing an auger therein;
an impeller housing in fluid communication with the auger housing, wherein the impeller housing contains an impeller therein;
an electric motor operatively coupled: to the auger and configured to rotate the auger about an auger axis; and to the impeller and configured to rotate the impeller about an impeller axis;
at least one sensor; and
an electronic controller operatively coupled to each of the electric motor and the sensor, the electronic controller configured to:
monitor data provided by the sensor; and
responsive to the data provided by the sensor, automatically adjust a parameter of the electric motor.

2. The snowthrower of claim 1, wherein the parameter comprises a speed of the electric motor.

3. The snowthrower of claim 1, wherein the sensor comprises an angle sensor configured to detect an inclination of the auger housing.

4. The snowthrower of claim 1, wherein the sensor comprises a current sensor configured to detect current to the electric motor.

5. The snowthrower of claim 1, wherein the sensor comprises a temperature sensor configured to detect a temperature of the electric motor.

6. The snowthrower of claim 1, wherein the sensor comprises a temperature sensor configured to detect an ambient air temperature.

7. The snowthrower of claim 1, further comprising:
first and second traction wheels associated with the auger housing; and
an electric traction motor operatively configured to rotate one or both of the first and second traction wheels to propel the snowthrower relative to a ground surface, wherein the traction motor is operatively coupled to the electronic controller.

8. The snowthrower of claim 7, wherein the electronic controller is further configured to, responsive to the data provided by the sensor, adjust a parameter of the traction motor.

9. The snowthrower of claim 8, wherein the parameter of the traction motor comprises a speed of the traction motor.

10. The snowthrower of claim 7, wherein the sensor is a current sensor configured to detect current to one or both of the electric motor and the traction motor.

11. The snowthrower of claim 7, further comprising operator controls operatively coupled to the electric traction motor, the operator controls comprising:
a first traction control configured to proportionally adjust rotational speed of the first traction wheel; and
a second traction control configured to proportionally adjust rotational speed of the second traction wheel.

12. A snowthrower comprising:
a frame defining a longitudinal axis;
a traction assembly supporting the frame relative to a ground surface, the traction assembly comprising at least one traction wheel;
an electric traction motor operatively coupled to the traction wheel and configured to rotate the traction wheel about a traction axis transverse to the longitudinal axis to propel the snowthrower over the ground surface; and
operator controls operatively coupled to the electric traction motor, the operator controls comprising:
a first traction control configured to command rotation of the traction wheel via the electric traction motor; and
first and second shift controls configured to adjust a rotational speed of the traction wheel via the electric traction motor;
wherein the rotational speed of the traction wheel is adjustable between a plurality of discrete speeds, the plurality of discrete speeds comprising:
a neutral speed; and
a first forward speed.

13. The snowthrower of claim 12, wherein the plurality of discrete speeds further comprises a first reverse speed.

14. A snowthrower comprising:
an auger housing containing an auger therein;
an impeller housing in fluid communication with the auger housing, wherein the impeller housing contains an impeller therein;
a motor assembly comprising an electric motor, the motor assembly operatively coupled to each of the auger and the impeller and configured to rotate each of the auger and the impeller about an auger axis and an impeller axis, respectively;
at least one sensor; and
an electronic controller operatively coupled to each of the motor assembly and the sensor, the electronic controller configured to:
monitor data provided by the sensor; and
responsive to the data provided by the sensor, automatically adjust a parameter of the motor assembly.

15. The snowthrower of claim 14, wherein the motor assembly further comprises a gearbox operatively coupled to each of the auger and the electric motor, and wherein the electric motor is configured to rotate the auger about the auger axis via the gearbox.

16. The snowthrower of claim 14, wherein the parameter of the motor assembly comprises a speed of the electric motor.

17. The snowthrower of claim 14, wherein the sensor comprises an angle sensor configured to detect an inclination of the auger housing.

18. The snowthrower of claim 14, wherein the sensor comprises a current sensor configured to detect current to the motor assembly.

19. The snowthrower of claim 14, wherein the sensor comprises a temperature sensor configured to detect a temperature of the motor assembly.

20. The snowthrower of claim 14, wherein the sensor comprises a temperature sensor configured to detect an ambient air temperature.
